(19) United States
(12) Patent Application Publication
(10) Pub. No.: US 2009/0320514 A1
(43) Pub. Date: Dec. 31, 2009

(54) Universal fluid flow transitional connector for use with refrigeration units of refrigerated trailers

(76) Inventors: Toby Clark, Phenix City, AL (US); Michael J. McMahon, Palatine, IL (US)

Correspondence Address: Steven W. Weinrieb;LAW OFFICES OF STEVEN W. WEINRIEB, 8717 Cold Spring Road, Potomac, MD, 20854, US

(21) Appl. No.: 12/213,848

(22) Filed: Jun. 25, 2008

(51) Int. Cl. F25D 17/04; B60H 1/00; B60H 1/32; B60P 3/20

(52) U.S. Cl. 62/407; 454/118; 454/90; 62/239

(57) ABSTRACT

A universal fluid flow transitional connector, for use in connection with refrigeration units disposed within refrigerated cargo trailers, has a corner configuration that is adapted to be mounted within the upper front corner region of the refrigerated cargo trailer as defined between the front wall member and the ceiling member of the trailer. In this manner, the connector can fluidically connect the cooled air outlet portion of the refrigeration unit to an air distribution chute member which is attached to and extends axially along the ceiling member of the trailer such that the cooled air, outputted from the refrigeration unit, can be distributed throughout the entire interior cargo space of the refrigerated trailer.

### FIELD OF THE INVENTION

The present invention relates generally to refrigeration systems disposed within refrigeration cargo trailers, and more particularly to a new and improved universal fluid flow transitional connector for use in connection with refrigeration units disposed within refrigerated cargo trailers wherein the fluid flow transitional connector has a corner configuration adapted to be mounted within the upper front corner region of the refrigerated cargo trailer, as defined between the front wall member and the ceiling member of the trailer, so as to fluidically connect the cooled air outlet portion of the refrigeration unit to an air distribution chute member which is attached to and extends axially along the ceiling member of the trailer such that the cooled air, outputted from the refrigeration unit, can be distributed throughout the entire interior cargo space of the refrigerated trailer, extending from, for example, the front wall member of the refrigerated trailer to the rear wall member of the refrigerated trailer, so as to effectively maintain a substantially uniform temperature level throughout the interior cargo space of the refrigerated trailer. The new and improved universal fluid flow transitional connector can also be used in connection with both types of conventional refrigeration units wherein, for example, in accordance with a first type of refrigeration unit, a rearward portion of the refrigeration unit will actually project a predetermined amount through the front wall member of the refrigerated trailer and into the interior cargo space of the refrigerated trailer, whereas in accordance with a second type of refrigeration unit, the rearward surface portion of the refrigeration unit will be disposed in a substantially coplanar or flush manner with respect to the front wall member of the refrigerated trailer.

### BACKGROUND OF THE INVENTION

Temperature-controlled cargo containers, such as, for example, refrigerated trucking trailers, are of course well known for transporting food or other products that need to be shipped under predetermined temperature-controlled conditions. Conventionally, a refrigerated trailer usually has a refrigeration unit mounted upon an upper region of the front wall member of the trailer wherein either a major portion of the refrigeration unit usually projects outwardly through the front wall member of the refrigerated trailer so as to effectively be located externally of the trailer with a corresponding minor portion of the refrigeration unit projecting into the interior portion of the refrigerated trailer, or alternatively, substantially the entire refrigeration unit projects outwardly through the front wall member of the refrigerated trailer such that the rearward facing wall member of the refrigeration unit is effectively disposed in a co-planar or flush manner with respect to the front wall member of the refrigerated trailer. Relatively warm air inlet and relatively cooled air outlet portions of the refrigeration unit are fluidically connected to the interior cargo space of the refrigeration trailer so as to continuously recirculate cooled or refrigerated air throughout the interior cargo space of the refrigeration trailer and therefore maintain the interior cargo space of the refrigerated trailer at, for example, a predetermined temperature level.

More particularly, the relatively warm air is effectively sucked into the air inlet portion of the refrigeration unit from regions of the refrigeration trailer which are disposed within the vicinity of the floor of the trailer, while cooled or refrigerated air is effectively forced outwardly from the air outlet portion of the refrigeration unit and into those regions of the refrigerated trailer which are disposed within the vicinity of the ceiling of the refrigeration trailer. In order to effectively facilitate or cause the relatively warmed air present within the refrigeration cargo trailer to be conducted toward and into the air inlet portion of the refrigeration unit, a vertically oriented air return bulkhead is operatively connected to the front wall member of the refrigeration trailer so as to substantially extend vertically between the air inlet portion of the refrigeration unit and the floor region of the refrigeration trailer. The air return bulkhead effectively defines a hollow enclosure whereby, for example, peripheral portions of the air return bulkhead can be attached to the front wall member of the refrigerated trailer, however, the central portion of the air return bulkhead is effectively spaced from the front wall member of the refrigeration trailer so as to effectively define a relatively warm return air conduit from the floor region of the refrigeration trailer to the air inlet portion of the refrigeration unit. An example of such a conventional mounting of a refrigeration unit upon a front wall member of a refrigerated trailer, and the use of an air return bulkhead mounted upon the front wall member of the refrigerated trailer so as to effectively define a relatively warm air return conduit for conducting relatively warm air from the floor region of the refrigeration trailer to the air inlet portion of the refrigeration unit, is disclosed, for example, within FIG. 1 of U.S. Pat. No. 7,351,136 which issued to Nelson et al. on Apr. 1, 2008, such disclosure being incorporated herein by reference.

In a similar manner, in order to cause or facilitate the cooled or refrigerated air to in fact flow toward the rear portion of the refrigerated trailer and to traverse substantially the entire axial extent of the interior cargo space within the refrigerated trailer such that a substantially uniform temperature level is in fact achieved throughout the entire axial length or extent of the interior cargo space of the refrigerated trailer, various types or configurations of ducting or fluid conduits are conventionally provided so as to extend along, or within the vicinity of, the interior ceiling surface portion of the refrigerated trailer. One type of such axially extending ducting or fluid conduit is also disclosed within FIG. 1 of the aforenoted U.S. Pat. No. 7,351,136 which issued to Nelson et al. on Apr. 1, 2008. In addition to the axially extending ducting or fluid conduit, a fluid flow transition member is also required to be interposed between the cooled air outlet portion of the refrigeration unit and the axially extending fluid conduit or ducting so as to effectively fluidically connect the cooled air outlet portion of the refrigeration unit to the axially extending ducting or fluid conduit so to fluidically conduct the cooled or refrigerated air from the cooled air outlet portion of the refrigeration unit into the axially extending ducting or fluid conduit.

While the system of Nelson et al. is operationally satisfactory, it is expensive to fabricate and must also be customized so as to be utilized within specified trailers. In other words, it is not necessarily capable of being used, for example, in connection with different refrigeration units having various different dimensions, particularly, for example, wherein the dimensions of the outlet portions of the various different refrigeration units will vary in size. In addition, the aforenoted system of Nelson et al. is not necessarily capable of being used in connection with both of the aforenoted conventional types of refrigeration units, that is, the first type of refrigeration unit wherein the rearward portion thereof projects through the front wall member of the refrigerated trailer so as to extend a predetermined amount into the interior cargo space of the refrigerated trailer, or the second type of refrigeration unit wherein the rear wall member of the refrigeration unit is effectively disposed in a coplanar or flush manner with respect to the front wall member of the refrigerated trailer. Other conventional prior art systems include the utilization of fluid flow transition members manufactured from suitable fabric materials which attach directly to the refrigeration unit, however, the mounting of such fabric structures directly upon the refrigeration units can potentially damage the refrigeration units both during installation of the fluid flow transition member thereon as well as during operation of the refrigeration unit. In addition, the fabric transition members are subject to deterioration or degradation over time, and therefore have relatively short service lives.

A need therefore exists in the art for a new and improved fluid flow transitional connector which is economical to fabricate, easy to install in a substantially indirect manner with respect to a refrigeration unit disposed within a refrigerated trailer, and can be universally used in connection with various different refrigeration units characterized by various different dimensions as well as modes of installation within the front wall member of the refrigerated trailer.

### SUMMARY OF THE INVENTION

The foregoing and other objectives are achieved in accordance with the teachings and principles of the present invention through the provision of a new and improved universal fluid flow transitional connector for use in connection with refrigeration units disposed within refrigerated cargo trailers, in order to fluidically connect the cooled air outlet portion of the refrigeration unit to an axially extending air distribution chute member so as to conduct the cooled air, outputted from the refrigeration unit, into the axially extending air distribution chute member such that the cooled air can be distributed throughout the entire interior cargo space of the refrigerated trailer extending from, for example, the front wall member of the refrigerated trailer to the rear wall member of the refrigerated trailer, so as to thereby effectively maintain a substantially uniform temperature level throughout the interior cargo space of the refrigerated trailer. In accordance with the principles and teachings of the present invention, the new and improved universal fluid flow transitional connector comprises, in effect, a hollow enclosure having a corner configuration which is therefore adapted to be fixedly secured to the front wall member of the refrigerated cargo trailer as well as to the ceiling member of the refrigerated cargo trailer. More particularly, the hollow enclosure effectively comprises, as considered in its orientation when the hollow enclosure, comprising the fluid flow transitional connector, is actually mounted upon the front wall member and the ceiling member of the refrigerated cargo trailer, a bottom wall member, a rear wall member in that the same faces toward the rear wall member of the refrigerated trailer, a pair of oppositely disposed side wall members, and a top wall member.

Each one of the bottom wall, side wall, and top wall members is provided with a peripheral edge portion which is adapted to be seated upon and fixedly secured, by means of suitable fasteners, to the front wall and ceiling members of the refrigerated cargo trailer, and the top wall member of the hollow enclosure projects axially rearwardly from the rear wall member of the hollow enclosure. In addition, the central portion of the top wall member of the hollow enclosure defines a downwardly curved or arcuate structure so as to effectively define a semi-cylindrical fluid conduit to which the forward end portion of an axially extending air distribution chute of the refrigeration cargo trailer can be fixedly but removably secured by any one of various different means. The bottom wall member of the hollow enclosure is effectively adapted to be seated upon, atop, or disposed immediately above the cooled air outlet portion of the refrigeration unit and has a flap member which may be fixedly secured within the bottom wall member of the hollow enclosure, or pivotally mounted with respect to the hollow enclosure as a result of being integrally attached thereto by means of a living hinge structure, as required.

More particularly, for example, when the new and improved universal fluid flow transitional connector is adapted to be used in conjunction with the first type of refrigeration unit wherein the rearward portion of the refrigeration unit projects through the front wall member of the refrigerated trailer so as to extend a predetermined amount into the interior cargo space of the refrigerated trailer, the pivotal disposition of the flap member with respect to the cooled air outlet portion of the refrigeration unit, is, in effect, inherently adjustable when the hollow enclosure, comprising the fluid flow transitional connector, is actually mounted upon the front wall member and the ceiling member of the refrigerated cargo trailer, so as to accommodate different refrigeration units which may project different amounts into the interior cargo space of the refrigerated trailer. On the other hand, when, for example, the new and improved universal fluid flow transitional connector is adapted to be used in conjunction with the second type of refrigeration unit wherein the rearward portion of the refrigeration unit is disposed in a coplanar or flush manner with respect to the front wall member of the refrigerated trailer, the flap member is fixed with respect to the bottom wall member of the enclosure.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a bottom perspective view of the new and improved universal fluid flow transitional connector as fixedly mounted within the upper front corner region of a refrigerated trailer, as defined between the front wall member and ceiling member of the refrigerated cargo trailer, so as to be interposed between, and thereby fluidically connect, the cooled air outlet end portion of the refrigeration unit to the cooled air inlet end portion of axially extending cool air distribution chute member fixedly mounted to and extending along the ceiling member;

FIG. 2 is a left side perspective view of the new and improved universal fluid flow transitional connector in its proper orientation so as to be fixedly mounted within the upper front corner region of the refrigerated trailer as defined between the front wall and ceiling members of the refrigerated cargo trailer, as illustrated within FIG. 1, so as to be interposed between, and thereby fluidically connect, the cooled air outlet end portion of the refrigeration unit to the inlet end portion of axially extending cool air distribution chute member, FIG. 2 illustrating in better perspective the downwardly curved or arcuate central portion of the top wall member of the hollow enclosure comprising the fluid flow transitional connector so as to effectively define the semi-cylindrical fluid conduit to which the forward end portion of the axially extending air distribution chute of the refrigeration cargo trailer, as illustrated within FIG. 1, is to be fixedly but removably secured;

FIG. 3 is a bottom plan view of the new and improved universal fluid flow transitional connector as illustrated within FIGS. 1 and 2, and illustrating the presence of the pivotal flap member integrally mounted upon the bottom wall member of the hollow enclosure, comprising the fluid flow transitional connector, by means of a living hinge structure;

FIG. 4 is a right side and bottom perspective view of the new and improved universal fluid flow transitional connector as illustrated within FIGS. 1-3, and likewise illustrating the presence of the pivotal flap member integrally mounted upon the bottom wall member of the hollow enclosure, comprising the fluid flow transitional connector, by means of the living hinge structure;

FIG. 5 is a front plan view of the new and improved universal fluid flow transitional connector as illustrated within FIGS. 1-4 and as viewed in the direction extending from the front wall member of the refrigerated trailer toward the rear wall member of the refrigerated trailer when the new and improved universal fluid flow transitional connector would be mounted upon the front wall and ceiling members of the refrigerated cargo trailer;

FIG. 6 is a substantially top plan view of the new and improved universal fluid flow transitional connector as illustrated within FIGS. 1-5 and as viewed in the direction extending downwardly from the ceiling of the refrigerated trailer toward the floor of the refrigerated trailer when the new and improved universal fluid flow transitional connector would be mounted upon the front wall and ceiling members of the refrigerated cargo trailer; and

FIG. 7 is a left side and top perspective view of the new and improved universal fluid flow transitional connector as illustrated within FIGS. 1-6 and as viewed in the direction extending downwardly from the ceiling of the refrigerated trailer toward the floor of the refrigerated trailer when the new and improved universal fluid flow transitional connector would be mounted within the upper front corner region of the refrigerated cargo trailer, as defined between the front wall member and the ceiling member of the refrigerated cargo trailer, and as correspondingly illustrated within FIG. 1.

### DETAILED DESCRIPTION OF THE PREFERRED EMBODIMENT

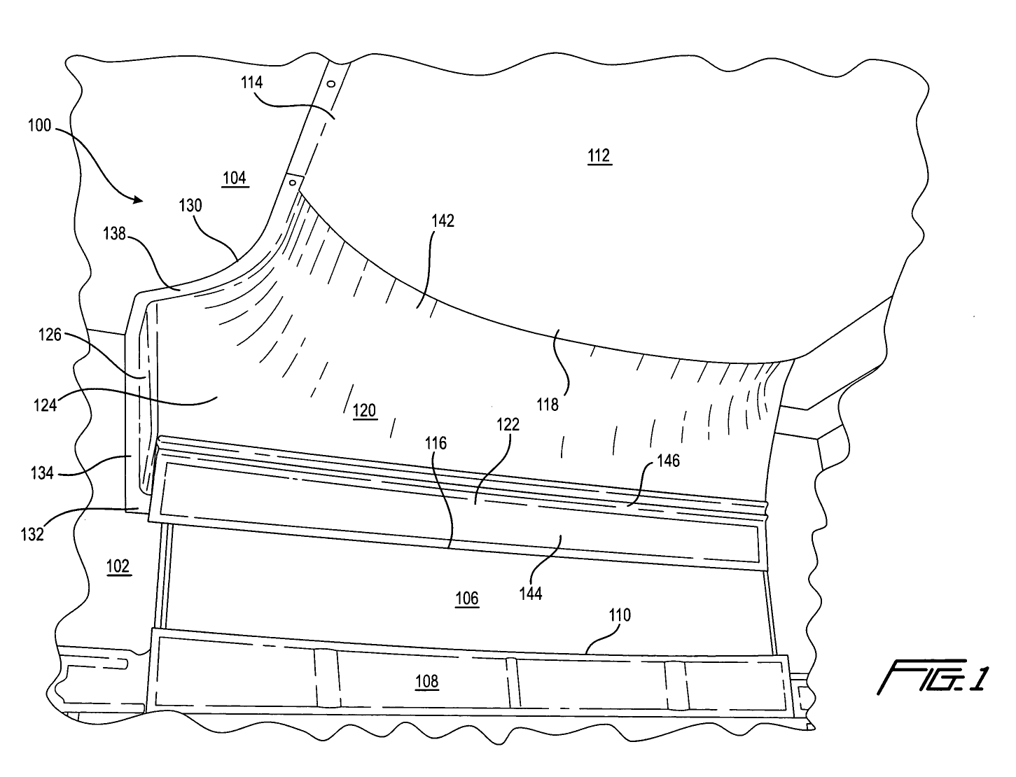

Referring now to the drawings, and more particularly initially to FIG. 1 thereof, a new and improved universal fluid flow transitional connector, as constructed in accordance with the principles and teachings of the present invention and showing the cooperative parts thereof, for use in connection with a refrigeration unit mounted upon the front wall member of a refrigerated trailer, is disclosed and is generally indicated by the reference character 100. The new and improved universal fluid flow transitional connector 100 is adapted to fluidically connect the cooled air outlet portion of the refrigeration unit to the inlet portion of an axially extending fabric-type air distribution chute which is adapted to be fixedly secured to the ceiling member of the refrigerated trailer in order to distribute the cooled refrigerated air throughout substantially the entire interior length of the cargo space of the refrigerated trailer. More particularly, it is seen the interior of the refrigerated trailer is defined in part, for example, by means of a front wall member 102 and a ceiling member 104. A refrigeration unit 106 is fixedly mounted upon the front wall member 102 of the refrigerated trailer, and an air return bulkhead 108, similar in function to the air return bulkhead as disclosed, for example, within the aforenoted patent to Nelson et al., is also adapted to be fixedly mounted upon the front wall member 102 of the refrigerated trailer so as to conduct relatively warm return air from the interior cargo space of the refrigerated trailer, and more particularly, to conduct relatively warm return air from the floor region of the interior cargo space of the refrigerated trailer, into an air inlet portion 110 of the refrigeration unit 106. An axially extending fabric-type air distribution chute 112 is adapted to be fixedly secured by suitable fastener means to the ceiling member 104 of the refrigerated trailer at, for example, axially or longitudinally extending peripheral edge portions thereof as exemplified by means of peripheral edge portion 114, in order to distribute the cooled refrigerated air throughout substantially the entire interior length of the cargo space of the refrigerated trailer, and the new and improved universal fluid flow transitional connector 100, as constructed in accordance with the principles and teachings of the present invention, is adapted to fluidically connect a cooled air outlet portion 116 of the refrigeration unit 106 to a cooled air inlet portion 118 of the longitudinally extending fabric-type air distribution chute 112.

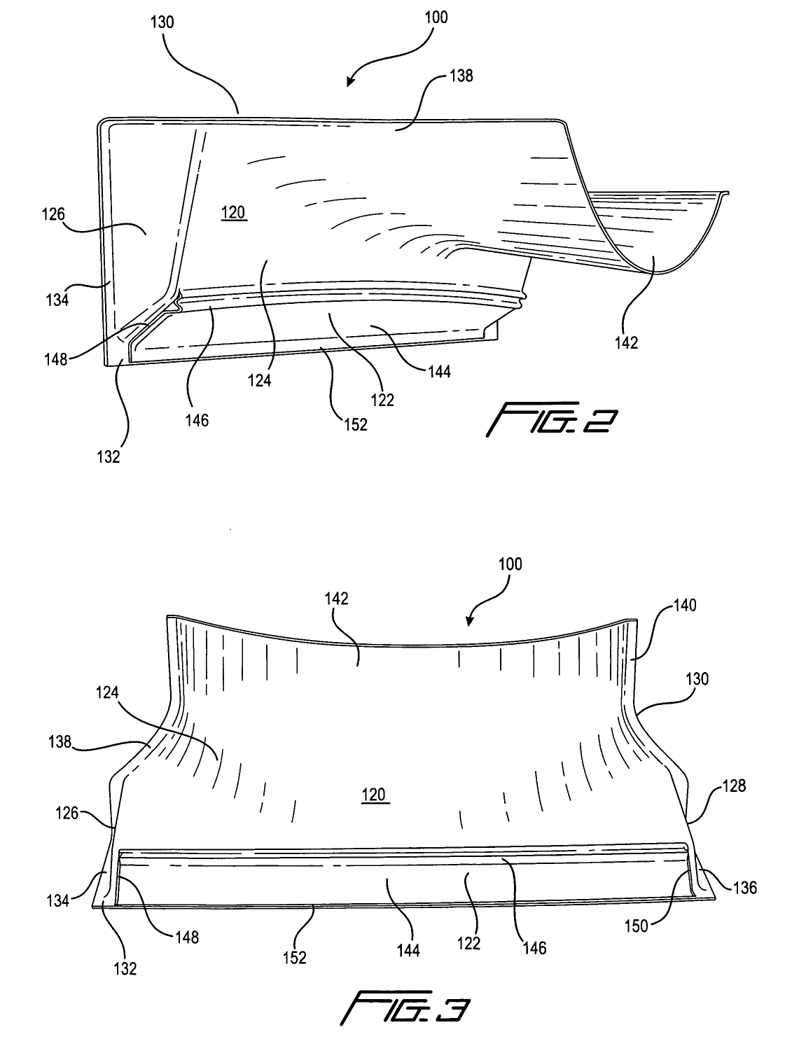

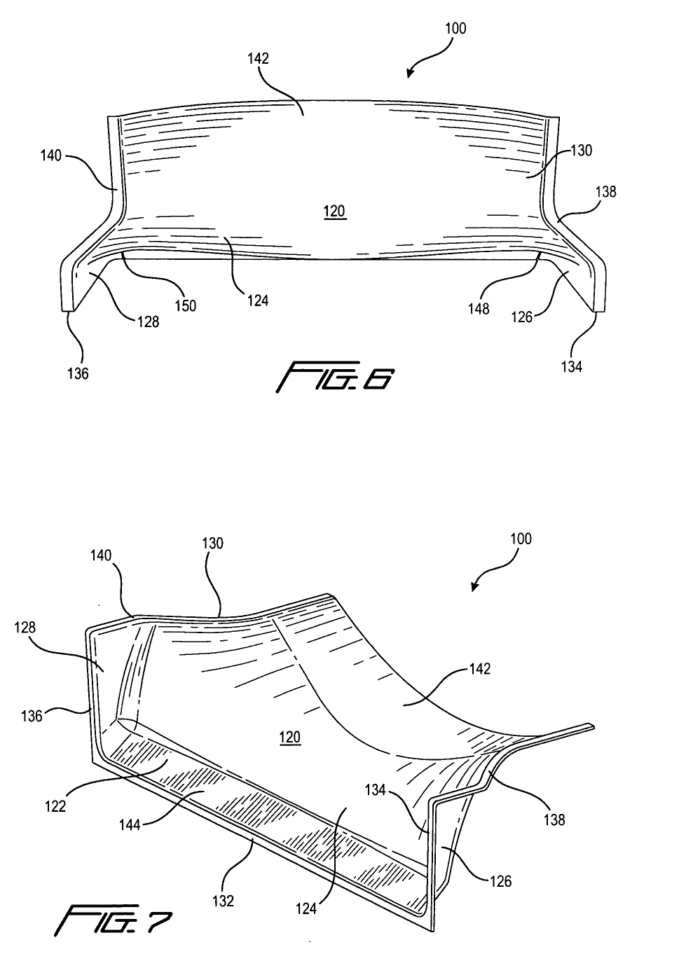

More particularly, with additional reference being made to FIGS. 2-7, in accordance with the principles and teachings of the present invention, the new and improved universal fluid flow transitional connector 100 is seen to comprise, in effect, a hollow enclosure 120 which, as has been previously noted, is adapted to be fixedly secured to the front wall member 102 of the refrigerated cargo trailer as well as to the ceiling member 104 of the refrigerated cargo trailer. More particularly, the hollow enclosure 120 may be fabricated as a thermoformed or vacuum-formed structure and effectively comprises, as considered in its orientation when the hollow enclosure 120 comprising the fluid flow transitional connector is actually mounted upon the front wall member 102 and the ceiling member 104 of the refrigerated cargo trailer, a bottom wall member 122, a rear wall member 124 in that the same faces toward the rear wall member of the refrigerated trailer, a pair of oppositely disposed side wall members 126,128, a top wall member 130, and a front wall member 132. Furthermore, it can be seen that the front wall member 132 comprises oppositely disposed peripheral edge or flanged portions 134,136, and that the top wall member 130 comprises oppositely disposed peripheral edge or flanged portions 138, 140 by means of which, for example, the opposite sides of the front wall member 132 and the laterally or transversely separated sections of the top wall member 130 are respectively adapted to be seated upon and fixedly secured, by means of suitable fasteners, to the front wall and ceiling members 102,104 of the refrigerated cargo trailer.

Continuing further, it is also seen that the rear wall member 124 begins to project rearwardly as the rear wall member 124 effectively approaches the top wall member 130 so as to effectively transition into the top wall member 130 whereby, as can best be seen, for example, within FIGS. 1-4, the axially central portion of the top wall member 130 effectively defines or forms a downwardly curved, arcuate, convex/concave structure 142 that projects or extends axially rearwardly from the rear wall member 124 of the hollow enclosure 120 comprising the new and improved universal fluid flow transitional connector 100. In this manner, the downwardly curved, arcuate, convex/concave structure 142 effectively forms a semi-cylindrical fluid conduit to which the forward end cooled air inlet portion 118 of the axially extending air distribution chute 112, disposed within the vicinity of, and attached at its peripheral edge portions 114 to, the ceiling portion 104 of the refrigeration cargo trailer, can be fixedly but removably secured by any one of various different fixation or fastener means. Such fixation or fastener means may include, for example, snap fasteners, zipper mechanisms, VELCRO® type fasteners, or the like. Examples of such fixation or fastener means are disclosed more fully within copending U.S. patent application entitled HEADER AND CHUTE ATTACHMENT IMPLEMENTS FOR HEADER-CHUTE ASSEMBLIES OF REFRIGERATION SYSTEMS which was filed on Feb. 12, 2007 and has been assigned Ser. No. 11/705,062 and which is incorporated herein by reference. Accordingly, it can be appreciated that by effectively interposing the new and improved universal fluid flow transitional connector 100, comprising the hollow enclosure 120, between the cooled air outlet portion of the refrigeration unit 106 and the cooled air inlet portion 118 of the axially extending air distribution chute 112, the cooled air from the refrigeration unit 106 can in fact be readily, easily, and quickly fluidically provided into the air distribution chute 112.

It is also to be emphasized that, unlike conventional prior art systems, the air distribution chute 112 is not attached to the refrigeration unit 106, and similarly, the universal fluid flow transitional connector 100 is likewise not attached to the refrigeration unit 106 but, to the contrary, is adapted to be fixedly secured to the front wall and ceiling members, 102,104 of the refrigerated trailer. In this manner, the universal fluid flow transitional connector 100 effectively serves as an air scoop wherein, for example, the bottom wall and rear wall members 122,124 thereof effectively surround the air outlet portion 116 of the refrigeration unit 106 so as to effectively capture, channel, or funnel the cooled air outputted from the air outlet portion 116 of the refrigeration unit 106 into the air distribution chute 112. It is noted still further that in order to permit the new and improved universal fluid flow transitional connector 100 to be utilized in conjunction with various different refrigeration units which may have various different size dimensions, the width of the enclosure 120, as defined, for example, between the oppositely disposed side wall members 126, 128, may be sufficiently large such that, for example, the bottom wall and rear wall members 122,124 of the enclosure 120 can effectively surround the air outlet portion of any conventional refrigeration unit.

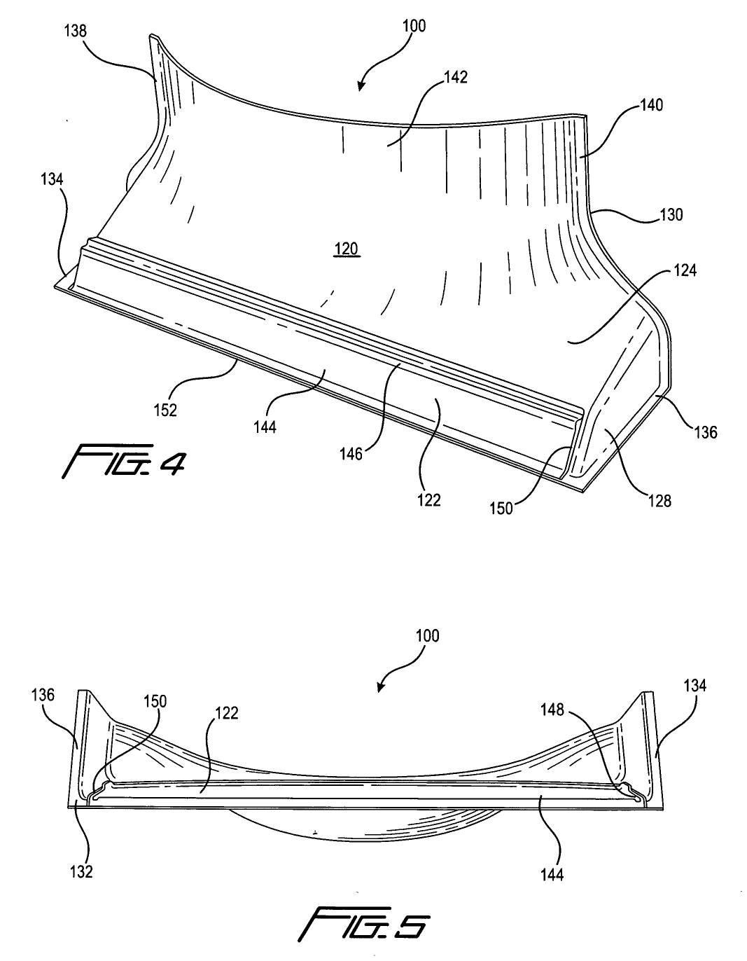

Still yet further, it is also to be noted that in order to permit the new and improved universal fluid flow transitional connector 100 to be utilized in conjunction with either one of the two previously noted types of conventional refrigeration units wherein a first type of refrigeration unit has its rearward portion actually projecting a predetermined amount through the front wall member of the refrigerated trailer and into the interior cargo space portion of the refrigeration trailer, or alternatively, wherein the second type of refrigeration unit has its rear wall member affixed or mounted in a substantially coplanar or flush manner with respect to the front wall member of the refrigerated trailer, it is lastly seen that the bottom wall member 122 of the new and improved universal fluid flow transitional connector 100 is sloped at a predetermined angle, as can best be appreciated, for example, from FIGS. 2 and 4, and that the bottom wall member 122 is effectively provided with a flap member 144 which is integrally connected at its uppermost and rearwardmost position to the rear wall member 124 by means of a suitable living hinge structure 146. It is to be noted, as can best be appreciated from FIGS. 2-4, that when the new and improved universal fluid flow transitional connector 100 is initially manufactured, oppositely disposed side edge portions of the bottom wall member 122 are effectively separated from the oppositely disposed side wall members 126,128 of the enclosure 120 by means of a pair of slits 148,150, however, it is also seen that the pair of slits 148,150 do not normally extend through to the lowermost or rearwardmost edge portion 152 of the bottom wall member 122.

In this manner, if the new and improved universal fluid flow transitional connector 100 is to be mounted within a refrigerated trailer wherein the rear wall member of the refrigeration unit is disposed in a coplanar or flush manner with respect to the front wall member 102 of the refrigerated trailer, then the new and improved universal fluid flow transitional connector 100 is mounted upon the front wall and ceiling members 102, 104 of the refrigerated trailer in the state shown in FIGS. 2-4, that is, with the flap member 144 fixedly mounted, in effect, within the bottom wall member 122 of the enclosure 120. Conversely, if the new and improved universal fluid flow transitional connector 100 is to be mounted within a refrigerated trailer wherein the rear wall member of the refrigeration unit projects a predetermined amount through the front wall member of the refrigerated trailer and into the interior cargo space region of the refrigerated trailer, then the slits 148,150 may be manually extended, such as, for example, by means of a suitably simple cutting operation, to the aforenoted lowermost or rearwardmost edge portion 152 of the bottom wall member 122 such that the flap member 144 is no longer fixedly mounted, in effect, within the bottom wall member 122 of the enclosure 120, but to the contrary, is now pivotally mounted with respect to, for example, the rear wall member 124 of the enclosure 120 by means of the living hinge structure 146 so as to in fact be capable of accommodating the rear end portion of the refrigeration unit as disclosed, for example, within FIG. 1. In this manner, it is to be further appreciated that the disposition of the flap member 144 with respect to the cooled air outlet portion 116 of the refrigeration unit 106, is, in effect, inherently adjustable when the hollow enclosure 120, comprising the fluid flow transitional connector 100, is actually mounted upon the front wall member 102 and the ceiling member 104 of the refrigerated cargo trailer such that the fluid flow transitional connector 100 can in fact accommodate, and be used in conjunction with, differently sized refrigeration units, that is, refrigeration units which may project different predetermined amounts through the front wall member of the refrigerated trailer and into the interior cargo space of the refrigerated trailer.

Thus, it may be seen that in accordance with the principles and teachings of the present invention, there has been provided a new and improved universal fluid flow transitional connector for use in connection with refrigeration units disposed within refrigerated cargo trailers in order to fluidically connect the cooled air outlet portion of the refrigeration unit to an axially extending air distribution chute member disposed within the vicinity of the ceiling member of the refrigerated cargo trailer. In this manner, the cooled air, outputted from the refrigeration unit, can be readily conducted into the axially extending air distribution chute member such that the cooled air can be distributed throughout the entire interior cargo space of the refrigerated trailer extending from, for example, the front wall member of the refrigerated trailer to the rear wall member of the refrigerated trailer, so as to effectively maintain a substantially uniform temperature level throughout the interior cargo space of the refrigerated trailer. The new and improved universal fluid flow transitional connector is not directly attached to the cooled air outlet portion of the refrigeration unit, but, to the contrary, the bottom wall and rear wall members thereof effectively surround the same so as to effectively serve as an air scoop whereby the cooled air outputted from the air outlet portion of the refrigeration unit can be channeled or funneled into the air distribution chute. In addition, the new and improved universal fluid flow transitional connector can be used in connection with conventional refrigeration units of various different dimensions, as well as in conjunction with both types of conventional refrigeration units wherein, for example, in accordance with a first type of refrigeration unit, a rearward portion of the refrigeration unit projects a predetermined amount through the front wall member of the refrigerated trailer and into the interior cargo space of the refrigerated trailer, whereas in accordance with a second type of refrigeration unit, the rearward surface portion of the refrigeration unit is disposed in a substantially coplanar or flush manner with respect to the front wall member of the refrigerated trailer.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A fluid flow transitional connector for use in connection with a refrigeration unit of a refrigeration container and an air distribution chute member of the refrigeration container, comprising:
an enclosure having a first end portion adapted to be fluidically connected to a cool air output end portion of a refrigeration unit mounted upon a front wall member of a refrigeration container, and a second end portion adapted to be fluidically connected to an air distribution chute member mounted upon a ceiling member of the refrigeration container so as to fluidically connect the cool air output end portion of the refrigeration unit to the air distribution chute member;
said enclosure having a corner structure adapted to be fixedly connected to the front wall member of the refrigeration container and to the ceiling member of the refrigeration container.

2. The fluid flow transitional connector as set forth in claim 1, wherein:
said enclosure comprises a front wall member, a rear wall member, a bottom wall member, a pair of oppositely disposed side wall members, and a top wall member.

3. The fluid flow transitional connector as set forth in claim 2, further comprising:
means for respectively attaching said front wall member and said top wall member of said enclosure to the front wall member of the refrigeration container and to the ceiling member of the refrigeration container.

4. The fluid flow transitional connector as set forth in claim 3, wherein:
said front wall member and said top wall member of said enclosure are provided with peripheral edge portions for facilitating the respective seating and attachment of said front wall member and said top wall member of said enclosure upon the front wall member of the refrigeration container and to the ceiling member of the refrigeration container.

5. The fluid flow transitional connector as set forth in claim 2, wherein:
said top wall member extends axially rearwardly from said rear wall member so as to be operatively connected to the air distribution chute member.

6. The fluid flow transitional connector as set forth in claim 5, wherein:
said top wall member comprises an axially central portion which defines a downwardly curved, arcuate, convex-concave structure for operative connection to the air distribution chute member.

7. The fluid flow transitional connector as set forth in claim 2, further comprising:
a flap member disposed within said bottom wall member; and
living hinge means pivotally connecting said flap member to said rear wall member of said enclosure for permitting said flap member to be moved between a first position at which said flap member is substantially flush with said bottom wall member of said enclosure so as to accommodate a refrigeration unit that does not project into the interior cargo space of the refrigeration container, and a second position at which said flap member is pivotally moved with respect to said rear wall member so as to accommodate a refrigeration unit that does project into the interior cargo space of the refrigeration container.

8. In combination, a fluid flow transitional connector for use in connection with a refrigeration unit of a refrigeration container and an air distribution chute member of the refrigeration container, comprising:
a refrigeration unit for providing refrigerated air to interior cargo space defined within a refrigeration container; and
an enclosure having a first end portion adapted to be fluidically connected to a cool air output end portion of said refrigeration unit mounted upon a front wall member of a refrigeration container, and a second end portion adapted to be fluidically connected to an air distribution chute member mounted upon a ceiling member of the refrigeration container so as to fluidically connect the cool air output end portion of said refrigeration unit to the air distribution chute member;
said enclosure having a corner structure adapted to be fixedly connected to the front wall member of the refrigeration container and to the ceiling member of the refrigeration container.

9. The combination as set forth in claim 8, wherein:
said enclosure comprises a front wall member, a rear wall member, a bottom wall member, a pair of oppositely disposed side wall members, and a top wall member.

10. The combination as set forth in claim 9, further comprising:
means for respectively attaching said front wall member and said top wall member of said enclosure to the front wall member of the refrigeration container and to the ceiling member of the refrigeration container.

11. The combination as set forth in claim 10, wherein:
said front wall member and said top wall member of said enclosure are provided with peripheral edge portions for facilitating the respective seating and attachment of said front wall member and said top wall member of said enclosure upon the front wall member of the refrigeration container and to the ceiling member of the refrigeration container.

12. The combination as set forth in claim 9, wherein:
said top wall member extends axially rearwardly from said rear wall member so as to be operatively connected to the air distribution chute member.

13. The combination as set forth in claim 12, wherein:
said top wall member comprises an axially central portion which defines a downwardly curved, arcuate, convex-concave structure for operative connection to the air distribution chute member.

14. The combination as set forth in claim 9, further comprising:
a flap member disposed within said bottom wall member of said enclosure; and
living hinge means pivotally connecting said flap member to said rear wall member of said enclosure for permitting said flap member to be moved between a first position at which said flap member is substantially flush with said bottom wall member of said enclosure so as to accommodate a refrigeration unit that does not project into the interior cargo space of the refrigeration container, and a second position at which said flap member is pivotally moved with respect to said rear wall member of said enclosure so as to accommodate a refrigeration unit that does project into the interior cargo space of the refrigeration container.

15. In combination, a fluid flow transitional connector for use in connection with a refrigeration unit of a refrigeration container and an air distribution chute member of the refrigeration container, comprising:
a refrigeration unit for providing refrigerated air to interior cargo space defined within a refrigeration container;
an air distribution chute member for distributing said refrigerated air from said refrigeration unit throughout the interior cargo space of the refrigeration container; and
an enclosure having a first end portion adapted to be fluidically connected to a cool air output end portion of said refrigeration unit mounted upon a front wall member of a refrigeration container, and a second end portion adapted to be fluidically connected to said air distribution chute member mounted upon a ceiling member of the refrigeration container so as to fluidically connect the cool air output end portion of said refrigeration unit to said air distribution chute member;
said enclosure having a corner structure adapted to be fixedly connected to the front wall member of the refrigeration container and to the ceiling member of the refrigeration container.

16. The combination as set forth in claim 15, wherein:
said enclosure comprises a front wall member, a rear wall member, a bottom wall member, a pair of oppositely disposed side wall members, and a top wall member.

17. The combination as set forth in claim 16, further comprising:
means for respectively attaching said front wall member and said top wall member of said enclosure to the front wall member of the refrigeration container and to the ceiling member of the refrigeration container.

18. The combination as set forth in claim 17, wherein:
said front wall member and said top wall member of said enclosure are provided with peripheral edge portions for facilitating the respective seating and attachment of said front wall member and said top wall member of said enclosure upon the front wall member of the refrigeration container and to the ceiling member of the refrigeration container.

19. The combination as set forth in claim 16, wherein:
said top wall member extends axially rearwardly from said rear wall member so as to be operatively connected to said air distribution chute member.

20. The combination as set forth in claim 19, wherein:
said top wall member comprises an axially central portion which defines a downwardly curved, arcuate, convex-concave structure for operative connection to said air distribution chute member.

21. The combination as set forth in claim 16, further comprising:
a flap member disposed within said bottom wall member of said enclosure; and
living hinge means pivotally connecting said flap member to said rear wall member of said enclosure for permitting said flap member to be moved between a first position at which said flap member is substantially flush with said bottom wall member of said enclosure so as to accommodate a refrigeration unit that does not project into the interior cargo space of the refrigeration container, and a second position at which said flap member is pivotally moved with respect to said rear wall member of said enclosure so as to accommodate a refrigeration unit that does project into the interior cargo space of the refrigeration container.
